(19) United States
(12) Patent Application Publication
(10) Pub. No.: US 2025/0153564 A1
(43) Pub. Date: May 15, 2025

(54) DISCONNECTOR APPARATUS

(71) Applicant: Hyundai Transys Inc., Seosan-si (KR)

(72) Inventor: Se Dong YANG, Hwaseong-si (KR)

(21) Appl. No.: 18/927,040

(22) Filed: Oct. 25, 2024

(30) Foreign Application Priority Data
Nov. 13, 2023 (KR) 10-2023-0156459

(51) Int. Cl. B60K 23/08; F16D 23/12; F16D 23/14

(52) U.S. Cl. CPC B60K 23/0808; F16D 23/14; F16D 2023/123

(57) ABSTRACT

A disconnector apparatus includes a casing, a first clutch ring having a first clutch part provided on an outer-diameter portion thereof, and a second clutch ring having one end connected to the first clutch ring and configured such that a second clutch part is provided at one side directed toward one side gear, which is mounted in the casing, and a sleeve is coupled to the other side outer-diameter portion.

### CROSS-REFERENCE TO RELATED APPLICATIONS

This application claims priority to and the benefit of Korean Patent Application No. 10-2023-0156459 filed in the Korean Intellectual Property Office on Nov. 13, 2023, the entire contents of which are incorporated herein by reference.

### TECHNICAL FIELD

The present invention relates to a disconnector apparatus capable of switching power to four-wheel drive or two-wheel drive and restricting a differential.

### BACKGROUND ART

In general, a disconnector apparatus refers to an apparatus mounted in a differential assembly and capable of minimizing an unnecessary loss of power by switching between two-wheel drive (2WD) and four-wheel drive (4WD) by engaging or disengaging a differential shaft depending on a traveling situation.

The disconnector apparatus in the related art includes a differential assembly, a disconnector shaft connected to a right differential side gear provided in a differential casing, a disconnector hub connected to a right vehicle wheel, and a disconnector sleeve configured to allow or block the transmission of power between the disconnector shaft and the disconnector hub. When the disconnector sleeve simultaneously engages with a dog gear part of the disconnector shaft and a dog gear part of the disconnector hub, an input part such as a motor or engine and an output part such as a vehicle wheel are dynamically connected to each other, such that four-wheel drive (4WD) may be implemented. When the disconnector sleeve moves toward the disconnector hub and the dog gear part of the disconnector shaft and the dog gear part of the disconnector hub disengage from each other, the transmission of power between the input part such as the motor or engine and the output part such as the vehicle wheel is blocked, such that two-wheel drive (2WD) may be implemented.

However, in the disconnector apparatus in the related art, the overall length and space of the vehicle excessively increase because of the complicated operational structure in which the ball screw shaft, the fork, and the disconnector sleeve are operated in conjunction with one another by the operation of the motor, and the disconnector shaft and the disconnector hub are connected by an operation of the disconnector sleeve, which causes disadvantages in respect to the weight and mountability of the vehicle. Further, in the case of two-wheel drive implemented by disconnecting an auxiliary driving wheel of a four-wheel drive vehicle, the final gear is stopped as the rotation of the input part is stopped, and a high differential occurs, in which the differential pinion gear is rotated at high speed by the rotation of the left differential side gear when the vehicle travels straight at high speed in the state in which the disconnector shaft and the disconnector hub are disconnected. For this reason, noise and vibration occur.

### Document of Related Art

### Patent Document

(Patent Document 1) Korean Patent Application Laid-Open No. 10-2017-0123869 (published on Nov. 9, 2017)

### SUMMARY OF THE INVENTION

The present invention has been made in an effort to solve the above-mentioned problem, and an object of the present invention is to provide a disconnector apparatus, in which a first clutch part of a first clutch ring may engage with a third clutch part of a casing by means of a first operation of a sleeve to implement four-wheel drive, or a second clutch part of a second clutch ring may engage with a fourth clutch part of one side gear by means of a second operation of the sleeve in a state in which the first clutch part and the third clutch part engage with each other to restrict a differential.

In order to achieve the above-mentioned object, the present invention provides a disconnector apparatus including: a casing; a first clutch ring having a first clutch part provided on an outer-diameter portion thereof; and a second clutch ring having one end connected to the first clutch ring and configured such that a second clutch part is provided at one side directed toward one side gear, which is mounted in the casing, and a sleeve is coupled to the other side outer-diameter portion, in which the first clutch ring connected to the second clutch ring is inserted into the casing by a first operation of the sleeve by a first operation of an actuator device connected to the sleeve, and the first clutch part engages with a third clutch part provided on one side inner-diameter portion of the casing, such that four-wheel drive is implemented.

In addition, in a state in which the first clutch part and the third clutch part engage, the second clutch ring may be moved toward one side gear by a second operation of the sleeve by a second operation of the actuator device, and the second clutch part may engage with a fourth clutch part provided at one side of one side gear, such that a differential may be restricted.

In addition, the first clutch ring may be connected to the sleeve by a spacer extending in a direction from one side toward the sleeve.

In addition, the first clutch part and the third clutch part may each be configured as a spline clutch, and the second clutch part and the fourth clutch part may each be configured as a dog clutch.

In addition, a support ring may be provided in the casing, a pinion gear may be provided in the support ring, and the pinion gear may engage with one side gear and the other side gear provided at two opposite sides.

In addition, a first gear part may be provided on an inner-diameter portion of the first clutch ring, and the first gear part may engage with a second gear part provided on one side outer-diameter portion of the support ring.

In addition, the sleeve may be connected to a fork, and the fork may be provided on a transfer nut of the actuator device.

In addition, the actuator device may include: a housing; a motor coupled to the housing; and a ball screw shaft connected to the motor, the transfer nut may be coupled to the ball screw shaft and move along the ball screw shaft while being guided by a guide rail mounted in the housing, and the fork may extend from the transfer nut toward the sleeve direction through an opening portion of the housing and be connected to the sleeve in the casing through a through-hole of the casing.

In addition, the guide rail may be elastically supported by an elastic member coupled to one end, one end of the elastic member may be inserted into a groove of the housing, and the other end of the elastic member may be assembled to be caught by a catching projection provided on the guide rail.

In addition, a power transmission member may be provided on an outer portion of the casing.

In addition, the power transmission member may be a ring gear and transmit power from the power generation device to the casing.

In addition, the power generation device may be an engine or a drive motor.

According to the present invention, the first clutch part of the first clutch ring may engage with the third clutch part of the casing by the first operation of the sleeve, such that the four-wheel drive may be implemented.

In addition, according to the present invention, the second clutch part of the second clutch ring may engage with the fourth clutch part of one side gear in the state in which the first clutch part and the third clutch part engage with each other by the second operation of the sleeve, such that the differential may be restricted.

In addition, according to the present invention, when the auxiliary driving wheels coast in the two-wheel drive mode in accordance with the disengagement between the second clutch part and the fourth clutch part and the disengagement between the first clutch part and the third clutch part, the support ring, which supports the differential gear set including the two side gears and the four pinion gears, rotates, which makes it possible to solve the problem of noise caused by a high differential in the related art.

In addition, according to the present invention, the actuator device is modularized, which makes it possible to ensure assembly properties, facilitate repair, and reduce a defect rate.

In addition, the present invention may significantly reduce the overall length, thereby reducing the weight and greatly improving the packaging mountability.

In addition, the present invention may eliminate a component such as a disconnector shaft in the related art and reduce the number of components by modularizing the actuator device, which provides advantages in respect to spatial characteristics, weight, and costs.

In addition, the present invention may simplify the assembling process by modularizing the actuator device.

In addition, according to the present invention, because the actuator device is modularized, the actuator device may be mounted in any speed reducer as long as the space for mounting the first clutch ring and the support ring is ensured, which makes it possible to reduce the development period and provide high versatility.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional side view of a disconnector apparatus according to an exemplary embodiment of the present invention.

FIG. 2 is a view illustrating a two-wheel drive state according to the exemplary embodiment of the present invention.

FIG. 3 is a view illustrating a four-wheel drive state according to the exemplary embodiment of the present invention.

FIG. 4 is a side view illustrating a differential restriction state according to the exemplary embodiment of the present invention.

FIG. 5 is a perspective view illustrating the differential restriction state according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may of course be modified and variously carried out by those skilled in the art.

The present invention may be applied to vehicles such as internal combustion engine (ICE) vehicles, hybrid electric vehicles (HEVs), and electric vehicles (EVs).

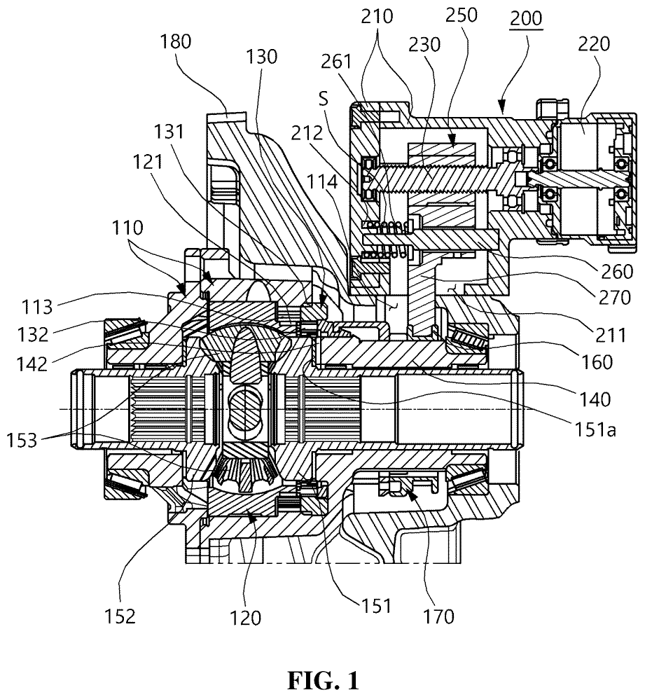

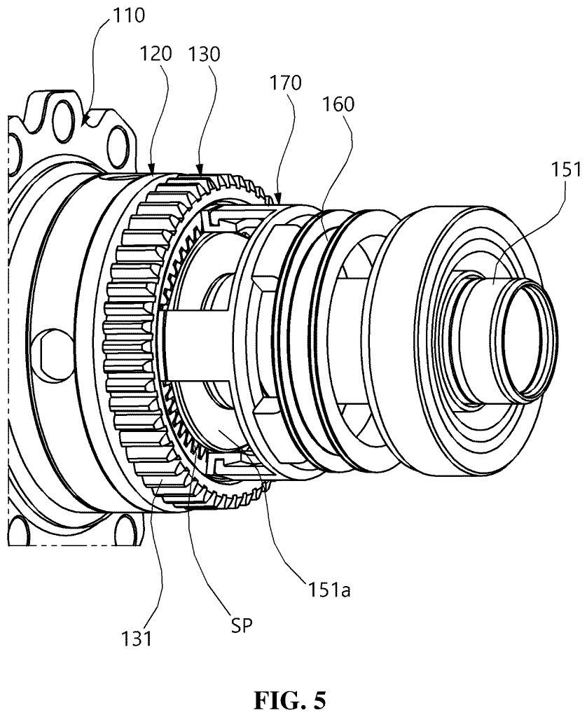

FIG. 1 is a cross-sectional side view of a disconnector apparatus according to an exemplary embodiment of the present invention, and FIG. 5 is a perspective view illustrating the differential restriction state according to the exemplary embodiment of the present invention.

As illustrated in FIGS. 1 and 5, the present invention may include a casing 110, a first clutch ring 130 for implementing four-wheel drive (4WD), and a second clutch ring 140 for restricting a differential.

A support ring 120, a pinion gear 153, and one side gear 151 and the other side gear 152, which engage with the pinion gear 153, may be mounted in the casing 110.

A power transmission member 180, such as a ring gear, may be provided on an outer portion of the casing 110. Power of a power generation device (not illustrated), such as an engine or a drive motor, may be transmitted to the power transmission member 180. The power transmitted to the power transmission member 180 may be transmitted to the casing 110.

The first clutch ring 130 may include a first clutch part 131. The first clutch part 131 may be provided on an outer-diameter portion of the first clutch ring 130.

The second clutch ring 140 may include a second clutch part 142. The second clutch part 142 may be provided at one side directed toward one side gear 151 of the second clutch ring 140.

For example, the second clutch part 142 may be configured as a dog clutch.

The first clutch part 131 may engage with a third clutch part 113 provided on one side inner-diameter portion of the casing 110. The second clutch part 142 may engage with a fourth clutch part 151a provided at one side of one side gear 151.

For example, the first clutch part 131 and the third clutch part 113 may each be configured as a spline clutch, and the second clutch part 142 and the fourth clutch part 151a may each be configured as a dog clutch.

The first clutch ring 130 may be connected to a sleeve 160 by a spacer 170.

One end of the second clutch ring 140 may penetrate the sleeve 160 and the spacer 170 and be connected to the first clutch ring 130.

The sleeve 160 may be coupled to an outer-diameter portion of the second clutch ring 140. The sleeve 160 may be connected to the second clutch ring 140. When the sleeve 160 moves, the first clutch ring 130 and the second clutch ring 140 may move together with the sleeve 160 in an engagement direction.

The pinion gear 153 may be mounted in the support ring 120. The pinion gear 153 may engage with one side gear 151 and the other side gear 152 provided at two opposite sides.

A first operation of the sleeve 160 may be performed by a first operation of an actuator device 200.

During the first operation, the sleeve 160 may move by a preset first stroke ST and move the first clutch ring 130, which is connected to the second clutch ring 140, toward the third clutch part 113 provided on the inner-diameter portion of the casing 110.

The first clutch ring 130 may be inserted into the casing 110 by the first operation of the sleeve 160, such that the first clutch part 131 of the first clutch ring 130 may engage with the third clutch part 113 of the casing 110. Therefore, the four-wheel drive may be implemented.

A second operation of the sleeve 160 may be performed by a second operation of the actuator device 200.

During the second operation, the sleeve 160 may move by a preset second stroke and move the second clutch ring 140 toward the fourth clutch part 151a of one side gear 151.

The second clutch part 142 may engage with the fourth clutch part 151a as the second clutch ring 140 is moved toward the fourth clutch part 151a of one side gear 151 by the sleeve 160. Therefore, the differential may be restricted.

The sleeve 160 may be connected to a fork 270. The fork 270 may be provided on a transfer nut 250 of the actuator device 200.

The actuator device 200 may include a housing 210, a motor 220, and a ball screw shaft 230. The motor 220 may be coupled to the housing 210. The ball screw shaft 230 may be connected to the motor 220 and configured to be rotated by an operation of the motor 220.

The ball screw shaft 230 may be rotatably supported in the housing 210 by means of a support member such as a bearing.

The transfer nut 250 may be provided in the housing 210. The transfer nut 250 may be coupled to the ball screw shaft 230. When the ball screw shaft 230 rotates, the transfer nut 250 may move along the ball screw shaft 230 while being guided by a guide rail 260 mounted in the housing 210.

An elastic member S may be coupled to one side of the guide rail 260. For example, the elastic member S may be a return spring. The elastic member S may elastically support the guide rail 260.

One side of the elastic member S may be inserted into a groove 212 of the housing 210. The other side of the elastic member S may be assembled to be caught by a catching projection 261 provided on the guide rail 260.

The fork 270 may extend in a direction from the transfer nut 250 toward the sleeve 160 through an opening portion 211 of the housing 210. The fork 270 may be connected to the sleeve 160, which is positioned in the casing 110, through a through-hole 114 of the casing 110. The fork 270 may move in the through-hole 114 of the casing 110.

A first gear part 132 may be provided on an inner-diameter portion of the first clutch ring 130. The first gear part 132 may engage with a second gear part 121 provided on one side outer-diameter portion of the support ring 120.

Next, an operation in the case of four-wheel drive of the present invention will be described.

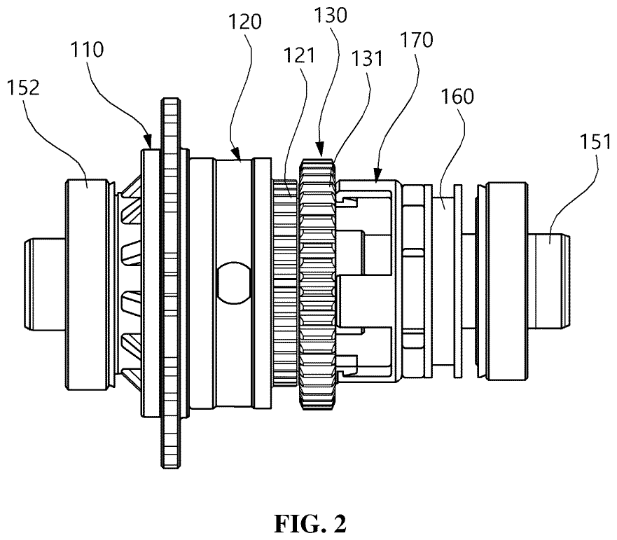

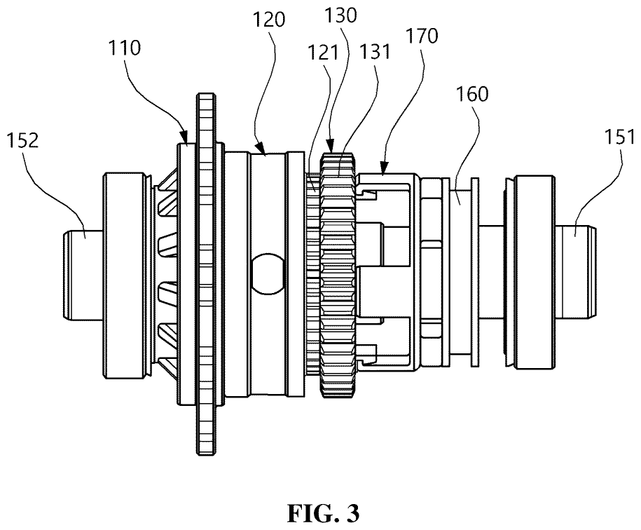

FIG. 2 is a view illustrating the two-wheel drive state according to the exemplary embodiment of the present invention, and FIG. 3 is a view illustrating the four-wheel drive state according to the exemplary embodiment of the present invention.

As illustrated in FIGS. 1 to 3, in the two-wheel drive (2WD) state in which the first clutch part 131 of the first clutch ring 130 and the third clutch part 113 of the casing 110 disengage, the transfer nut 250 may move in the engagement direction as the ball screw shaft 230 is rotated by the operation of the motor 220 of the actuator device 200.

When the transfer nut 250 moves, the fork 270 integrated with the transfer nut 250 may move the sleeve 160.

Specifically, the sleeve 160 may move by the preset first stroke while performing the first operation by the first operation of the actuator device 200.

As the sleeve 160 moves by the first stroke while performing the first operation, the first clutch ring 130 connected to the second clutch ring 140 may be moved toward the third clutch part 113 of the casing 110 by the sleeve 160.

As the first clutch ring 130 moves toward the third clutch part 113 of the casing 110, the first clutch part 131 of the first clutch ring 130 may engage with the third clutch part 113 of the casing 110. Therefore, the four-wheel drive (4WD) may be implemented.

For example, a spline may be formed on an inner-diameter portion of one end of the spacer 170 directed toward one side gear 151, and a spline may be formed on an outer-diameter portion of one side gear 151, such that the inner-diameter portion of the spacer 170 and the outer-diameter portion of one side gear 151 may engage with each other through the splines SP.

In the case of the four-wheel drive, the power of the power generation device (not illustrated), such as the engine or the drive motor, may be transmitted to the power transmission member 180.

The power of the power generation device (not illustrated) may be transmitted to the casing 110 via the power transmission member 180. The support ring 120 may rotate as the casing 110 rotates.

The support ring 120 may rotate together with the casing 110 in the state in which the second gear part 121, which is provided on one side outer-diameter portion directed toward the first clutch ring 130, engages with the first gear part 132 provided on the inner-diameter portion of the first clutch ring 130.

When the support ring 120 rotates together with the casing 110, the power may be transmitted to one side gear 151 and the other side gear 152 that engage with the pinion gear 153, such that one side gear 151 and the other side gear 152 may rotate.

When one side gear 151 and the other side gear 152 rotate, the power may be transmitted to two opposite auxiliary driving wheels (not illustrated) connected to one side gear 151 and the other side gear 152, such that the two opposite auxiliary driving wheels (not illustrated) may rotate. Therefore, the four-wheel drive may be implemented as the power of the power transmission device (not illustrated) is transmitted to the auxiliary driving wheels (not illustrated) as well as main driving wheels (not illustrated).

Next, an operation in the case of differential restriction of the present invention will be described.

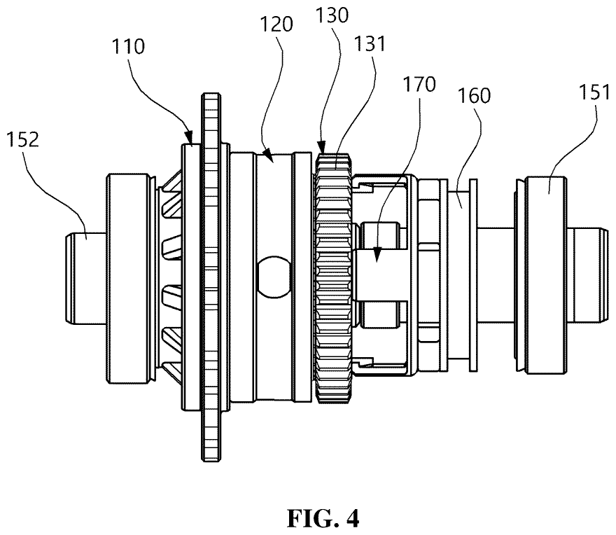

FIG. 4 is a side view illustrating a differential restriction state according to the exemplary embodiment of the present invention.

As illustrated in FIGS. 1, 4, and 5, in the state in which the first clutch part 131 engages with the third clutch part 113, the sleeve 160 may move by the preset second stroke while performing the second operation by the second operation of the actuator device 200.

When the sleeve 160 moves by the second stroke while performing the second operation, the second clutch ring 140 connected to the sleeve 160 may move toward the fourth clutch part 151a of one side gear 151.

When the second clutch ring 140 moves toward the fourth clutch part 151a of one side gear 151, the second clutch part 142 of the second clutch ring 140 may engage with the fourth clutch part 151a of one side gear 151. Therefore, the differential may be restricted.

For example, in case that one driving wheel of a vehicle is placed on a rough road, such as a bog, in a differential state, rotational resistances applied to the left and right driving wheels become different. For this reason, a relative difference in speeds between one side gear 151 and the other side gear 152 occurs, and the driving wheel placed in the rough road idles, which makes it impossible for the driving wheel to escape from the rough road.

However, in the present invention, in a differential restriction state in which the first clutch part 131 engages with the third clutch part 113 and the second clutch part 142 engages with the fourth clutch part 151a, one side gear 151 and the other side gear 152 rotate at the same speed, such that one driving wheel may easily escape from a rough road even though the driving wheel is placed in the rough road such as a bog.

Next, an operation in the case of two-wheel drive of the present invention will be described.

As illustrated in FIGS. 1 and 2, in the state in which the first clutch part 131 and the third clutch part 113 engage and the second clutch part 142 and the fourth clutch part 151a engage, the sleeve 160 may move in a disengagement direction by the operation of the actuator device 200.

When the sleeve 160 moves in the disengagement direction, the second clutch ring 140 connected to the sleeve 160 may move in the disengagement direction, and the first clutch ring 130 connected to the second clutch ring 140 may also move in the disengagement direction.

When the first clutch ring 130 and the second clutch ring 140 moves in the disengagement direction, the first clutch part 131 and the third clutch part 113 may disengage, and the second clutch part 142 and the fourth clutch part 151a may disengage. Therefore, the two-wheel drive (2WD) may be implemented.

During the two-wheel drive, the two opposite auxiliary driving wheels (not illustrated) may coast, and the rotational forces of the two opposite auxiliary driving wheels are transmitted to one side gear 151 and the other side gear 152, such that one side gear 151 and the other side gear 152 may rotate.

When one side gear 151 and the other side gear 152 rotate in the state in which one side gear 141 and the other side gear 142 engage with the pinion gear 153, the support ring 120 may also rotate together with one side gear 151 and the other side gear 152.

When the support ring 120 freely rotates in the casing 110, the two-wheel drive (2WD) traveling may be implemented in which the auxiliary driving wheels (not illustrated) coast, and only the main driving wheels (not illustrated) operate.

For example, because the electric vehicle travels at a high rotational speed, high differential noise may certainly occur. However, the present invention may solve the problem of the occurrence of high differential noise in the related art because the support ring 120 rotates in the casing 110.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A disconnector apparatus comprising:
a casing;
a first clutch ring having a first clutch part disposed on an outer-diameter portion thereof; and
a second clutch ring having one end connected to the first clutch ring, the second clutch ring having a second clutch part disposed at one side of the second clutch ring directed toward one side gear, which is mounted in the casing,
wherein a sleeve is coupled to an outer-diameter portion of the second clutch ring at another side of the second clutch ring, and
wherein the first clutch ring connected to the second clutch ring is configured to be inserted into the casing by a first operation of the sleeve by a first operation of an actuator device connected to the sleeve, and the first clutch part is configured to engage with a third clutch part disposed on an inner-diameter portion of the casing at one side of the casing to implement four-wheel drive.

2. The disconnector apparatus of claim 1, wherein in a state in which the first clutch part and the third clutch part engage, the second clutch ring is configured to be moved toward the one side gear by a second operation of the sleeve by a second operation of the actuator device, and the second clutch part is configured to engage with a fourth clutch part disposed at one side of the one side gear to restrict a differential.

3. The disconnector apparatus of claim 1, wherein the first clutch ring is connected to the sleeve by a spacer extending in a direction from one side of the first clutch ring toward the sleeve.

4. The disconnector apparatus of claim 2, wherein each of the first clutch part and the third clutch part has a spline clutch, and each of the second clutch part and the fourth clutch part has a dog clutch.

5. The disconnector apparatus of claim 1, wherein a support ring is disposed in the casing, a pinion gear is disposed in the support ring, and the pinion gear is configured to engage with the one side gear and an other side gear disposed at two opposite sides of the pinion gear.

6. The disconnector apparatus of claim 5, wherein a first gear part is disposed on an inner-diameter portion of the first clutch ring, and the first gear part is configured to engage with a second gear part disposed on an outer-diameter portion of the support ring at one side of the support ring.

7. The disconnector apparatus of claim 1, wherein the sleeve is connected to a fork, and the fork is disposed on a transfer nut of the actuator device.

8. The disconnector apparatus of claim 7, wherein the actuator device comprises:
a housing;
a motor coupled to the housing; and
a ball screw shaft connected to the motor, and
wherein the transfer nut is coupled to the ball screw shaft and configured to move along the ball screw shaft while being guided by a guide rail mounted in the housing, and the fork extends from the transfer nut toward the sleeve through an opening portion of the housing, the fork being connected to the sleeve in the casing through a through-hole of the casing.

9. The disconnector apparatus of claim 8, wherein the guide rail is elastically supported by an elastic member coupled to one end of the guide rail, one end of the elastic member is disposed in a groove of the housing, and another end of the elastic member is configured to be caught by a catching projection defined on the guide rail.

10. The disconnector apparatus of claim 1, wherein a power transmission member is disposed on an outer portion of the casing.

11. The disconnector apparatus of claim 10, wherein the power transmission member is a ring gear, the power transmission member being configured to transmit power from a power generation device to the casing.

12. The disconnector apparatus of claim 11, wherein the power generation device is an engine or a drive motor.
